(19) United States
(12) Patent Application Publication
(10) Pub. No.: US 2022/0164812 A1
(43) Pub. Date: May 26, 2022

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Sayaka TAKAHASHI, Tokyo (JP); Jun UCHIMURA, Tokyo (JP)

(73) Assignee: NEC Corporation, Minato-ku, Tokyo (JP)

(21) Appl. No.: 17/432,566

(22) PCT Filed: Mar. 3, 2020
(86) PCT No.: PCT/JP2020/008973

§ 371 Date: Aug. 20, 2021

(30) Foreign Application Priority Data
Mar. 25, 2019 (JP) 2019-055918

(51) Int. Cl. G06Q 30/02

(52) U.S. Cl. CPC G06Q 30/0203; G08B 21/02; G06Q 30/0269

(57) ABSTRACT

An information processing device 400 includes an attribute estimation unit 410, an input/output control unit 411, and an output unit 412. The attribute estimation unit 410 estimates, on the basis of imaging data in which a customer who visits a store is imaged, an attribute of the customer. The input/output control unit 411 outputs a survey to an output device in a store and receives an answer to this survey. The output unit 412 includes an output unit 412 that outputs an estimated attribute and a received answer in association with each other.

### TECHNICAL FIELD

The present disclosure relates to an information processing device, a management system, an information processing method, and a recording medium.

### BACKGROUND ART

In recent years, a technology of using a digital signage arranged in various places such as outdoors, storefronts, public spaces, and transportation facilities as an advertisement medium has been provided.

For example, PTL 1 discloses a technology of switching a display content (contents) of such digital signage. PTL 1 discloses a digital signage control device that receives e-mail and updates the contents of the digital signage. In this digital signage control device, frequent updating of the contents is suppressed, and the contents with high priority are preferentially displayed.

PTL 2 discloses an advertisement distribution system capable of counting a click through rate (CTR) of advertisement information in a digital signage system.

PTL 3 discloses a sales system capable of advertising more easily and effectively. In this sales system, advertisement content information is stored in a flash memory, and a central processing unit (CPU) additionally prints advertisement data according to the advertisement content information designated from a touch panel on a receipt when issuing the receipt.

### CITATION LIST

### Patent Literature

[PTL 1] JP 2016-177435 A
[PTL 2] JP 2012-098991 A
[PTL 3] JP 11-328538 A

### SUMMARY OF INVENTION

### Technical Problem

As described above, the technology of effectively switching the contents displayed on the digital signage and measuring a reaction of a user to the displayed contents is disclosed, but reception of an input from a customer is not disclosed. There is a problem that the input takes time and effort for the customer.

An object of the present disclosure is to provide an information processing device, a management system, an information processing method, and a program capable of solving the above-described problems and receiving an input from a customer while saving time and effort.

### Solution to Problem

An information processing device according to an aspect of the present disclosure includes an attribute estimation means that estimates, based on imaging data in which a customer who visits a store is imaged, an attribute of the customer, an input/output control means that outputs a survey to an output device in the store and receives an answer to the survey, and an output means that outputs the estimated attribute and the received answer in association with each other.

An information processing method according to an aspect of the present disclosure includes estimating, based on imaging data in which a customer who visits a store is imaged, an attribute of the customer, outputting a survey to an output device in the store and receiving an answer to the survey, and outputting the estimated attribute and the received answer in association with each other.

A management system according to an aspect of the present disclosure includes an information processing device that includes an attribute estimation means that estimates, based on imaging data in which a customer who visits a store is imaged, an attribute of the customer, an input/output control means that outputs a survey to an output device in the store and receives an answer to the survey, and an output means that outputs the estimated attribute and the received answer in association with each other to another information processing device communicably connected to the information processing device.

A recording medium according to an aspect of the present disclosure records a program for causing a computer to execute processing of estimating, based on imaging data in which a customer who visits a store is imaged, an attribute of the customer, outputting a survey to an output device in the store and receiving an answer to the survey, and outputting the estimated attribute and the received answer in association with each other.

### Advantageous Effects of Invention

One of the effects of the present disclosure is that it is possible to receive an input from a customer while saving time and effort.

### BRIEF DESCRIPTION OF DRAWINGS

FIG. 1 is a block diagram illustrating an example of a configuration of an information processing system according to a first example embodiment.

FIG. 2 is a view illustrating hardware configurations of an information processing device and a digital signage.

FIG. 3 is a flowchart illustrating an example of an operation of the information processing system according to the first example embodiment.

FIG. 4 is a view illustrating an example of an attribute estimated by an attribute estimation unit of the information processing system according to the first example embodiment.

FIG. 5A is a view illustrating a display example of the digital signage by an input/output control unit of the information processing system according to the first example embodiment.

FIG. 5B is a view illustrating a display example of the digital signage by an input/output control unit of the information processing system according to the first example embodiment.

FIG. 5C is a view illustrating a display example of the digital signage by an input/output control unit of the information processing system according to the first example embodiment.

FIG. 6 is a view illustrating an example of an attribute of a customer and a survey answer stored in a storage unit of the information processing system according to the first example embodiment.

FIG. 7 is a block diagram illustrating a configuration of an information processing system according to a second example embodiment.

FIG. 8 is a view illustrating a hardware configuration of a voice recognition device.

FIG. 9 is a block diagram illustrating a configuration of an information processing system according to a third example embodiment.

FIG. 10 is a view illustrating an example of customer identification information.

FIG. 11 is a flowchart illustrating an example of an operation of the information processing system according to the third example embodiment.

FIG. 12 is a view illustrating an example of associated information stored in a storage unit of an information processing system according to a fourth example embodiment.

FIG. 13 is a block diagram illustrating an example of a configuration of an information processing device according to a fifth example embodiment.

### EXAMPLE EMBODIMENT

Example embodiments are described in detail with reference to the drawings. In the drawings and the example embodiments described in the specification, similar components are denoted by the same reference sign, and the description thereof is not repeated as appropriate.

### First Example Embodiment

A first example embodiment is described.

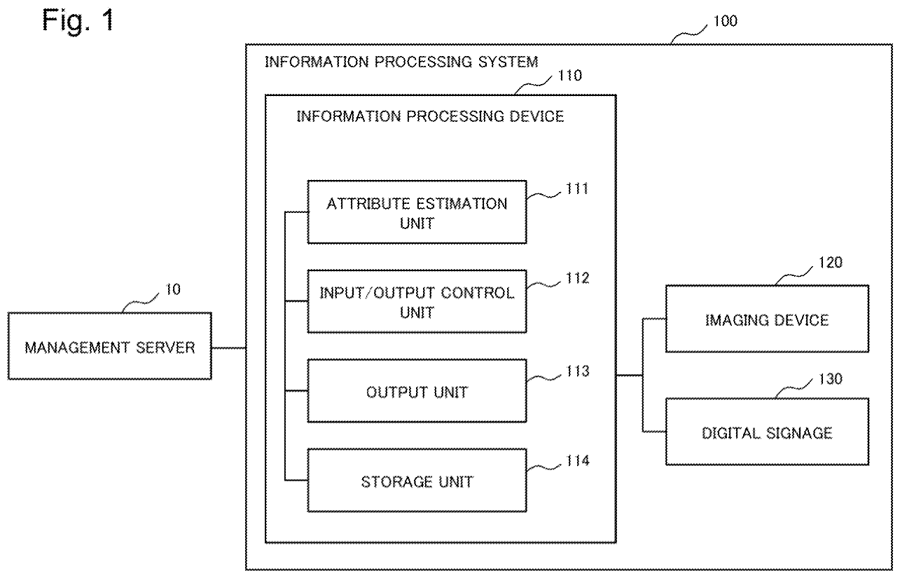

FIG. 1 is a block diagram illustrating an example of a configuration of an information processing system 100 according to the first example embodiment. As illustrated in FIG. 1, the information processing system 100 includes an information processing device 110, an imaging device 120, and a digital signage 130. The imaging device 120 and the digital signage 130 are installed in a retail store such as a convenience store and a supermarket, for example.

The information processing device 110 is, for example, a computer, and performs processing of controlling each device such as the imaging device 120 and the digital signage 130, obtaining information from each device, and analyzing the obtained information.

The information processing system 100 is communicably connected to a management server 10. The management server 10 is, for example, a computer, and performs item management, customer management and the like in this store. For example, the management server 10 may have a function of performing ordering processing of items in this store. The management server 10 may manage items and customers of other stores in addition to the items and customers of this store. The management server 10 may be installed in the store, or may be arranged in a place different from the store and connected to the information processing system 100 via a communication network. That is, the management server 10 may be achieved by a cloud computing system. The management server 10 corresponds to another information processing device. The information processing device 110 and the management server 10 may form a management system.

The imaging device 120 is, for example, a camera or a video camera that is built in, externally attached to, or installed in the vicinity of the digital signage 130 capable of imaging the vicinity of the digital signage 130. The imaging device 120 may also be a camera or a video camera installed in various places such as the ceiling and a wall surface of the store, for example. The imaging device 120 may be installed in such a way that at least imaging data capable of identifying an attribute of a customer is obtained. The imaging device 120 notifies the information processing device 110 of generated imaging data. The imaging data being a moving image or a still image of which the information processing device 110 is notified may be stored in a storage unit 114.

The digital signage 130 is a device that includes an output device and an input device used as, for example, an advertisement medium. The digital signage 130 outputs information under control of the information processing device 110, receives an input from the customer, and notifies the information processing device 110 of the same. In the present example embodiment, the output device is a display device. In the present example embodiment, the digital signage 130 includes a touch panel in which the display device and the input device are integrated. The digital signage 130 may also be formed integrally with the information processing device 110. The digital signage 130 is not limited to a digital signage as long as this is a device at least including the output device and the input device and having a function capable of communicating with the information processing device 110.

An installation place of the digital signage 130 is not particularly limited. For example, the digital signage 130 may be installed in the vicinity of an entrance of the store, may be installed on an item shelf, a door of the item shelf, a window of the store and the like, or may be installed on a floor of the store. Alternatively, the digital signage 130 may be installed outside the store.

The information processing system 100 may be used not only in a normal stores but also in a labor-saving store and an unmanned stores. Each of the labor-saving store and unmanned store is a small store in which, for the purpose of improving operation efficiency and deploying in a small trading area, a computer system reduces work of a store staff regarding registration and payment of purchased items, customer service support, in-store monitoring, inventory management, facility management and the like, and reduces the number of resident store staffs from that in the normal store or to zero.

The information processing system 100 may be used in a mother store that manages the labor-saving store and unmanned store, and in the labor-saving store and unmanned store (child store). For example, the imaging device 120 and the digital signage 130 may be installed in the child store, and may be connected to the information processing device 110 installed in the mother store via the communication network. A part of functional components of the information processing device 110 may be installed in the child store. The arrangement configuration of the information processing system 100 is not limited to this.

<Functional Configuration of Information Processing Device 110>

Each functional component of the information processing device 110 is described.

The information processing device 110 includes an attribute estimation unit 111, an input/output control unit 112, an output unit 113, and the storage unit 114.

On the basis of the imaging data obtained from the imaging device 120, the attribute estimation unit 111 detects an imaged customer and estimates an attribute of the customer. The customer may be detected using an existing method or means such as a method based on a background difference or a discriminator that has learned a feature of a person.

Specific examples of the attribute of the customer include age (age group) and sex. Here, an example of a method of estimating the age and sex as the attributes from the imaging data of the customer is described. First, learning data in which a feature amount of a face of the customer is associated with the age and sex is created in advance, and is stored in the storage unit 114 as a database, for example. The attribute estimation unit 111 extracts a face from the imaging data obtained from the imaging device 120 and calculates a feature amount of the extracted face. The attribute estimation unit 111 estimates the age and sex of the customer by comparing the calculated feature amount with the feature amount in the database.

The attribute estimation unit 111 may also estimate the attributes such as a body height, a body shape, clothes, a family structure, an occupation, and customer's hobby and taste. They may be estimated, for example, by creating in advance learning data associated with external features such as clothes, decorations, and hairstyles of the customer and storing the same in the database similarly. The method of estimating the attribute of the customer is not limited to the above-described method. The attribute estimation unit 111 corresponds to an attribute estimation means that estimates, on the basis of imaging data in which a customer who visits a store is imaged, an attribute of this customer.

The input/output control unit 112 controls input/output to/from the digital signage 130. In the storage unit 114, for example, survey data is stored. A survey included in the survey data may include a content for accepting a customer's request such as an item request. The survey may include, for example, a content regarding an item sold in the store or a content regarding an item not sold. The survey may include, for example, a content for allowing selection of an item wanted to be sold in the store. The storage unit 114 may store various advertisement data.

The input/output control unit 112 reads out the survey data from the storage unit 114 and allows the display device of the digital signage 130 to display the survey based on the survey data. The input/output control unit 112 also receives an answer input to the input device of the digital signage 130. The input/output control unit 112 corresponds to an input/output control means that outputs a survey to an output device in a store and receives an answer to this survey. Here, the output device corresponds to a digital signage.

The output unit 113 transmits the attribute estimated by the attribute estimation unit 111 and the answer to the survey obtained by the input/output control unit 112 to the management server 10 in association with each other. The output unit 113 corresponds to an output means that outputs an estimated attribute and a received answer in association with each other.

The storage unit 114 stores the survey data. The storage unit 114 stores the attribute of the customer estimated by the attribute estimation unit 111 and the survey answer of this customer obtained by the input/output control unit 112 in association with each other. The storage unit 114 may also store the imaging data of which this is notified by the imaging device 120. The survey data is not limited to be stored in the storage unit 114. The survey data may be stored in the management server 10 or may be stored in another storage device. It is sufficient that the input/output control unit 112 reads out the survey data from the storage device in which the survey data is stored.

<Hardware Configuration>

Each functional component of the information processing device 110 and the digital signage 130 may be implemented by hardware (for example, a hard-wired electronic circuit and the like) that implements each functional component, or may be implemented by a combination of hardware and software (for example, a combination of an electronic circuit and a program that controls the same and the like). Hereinafter, a case where each functional component of the information processing device 110 and the digital signage 130 is implemented by the combination of hardware and software is described.

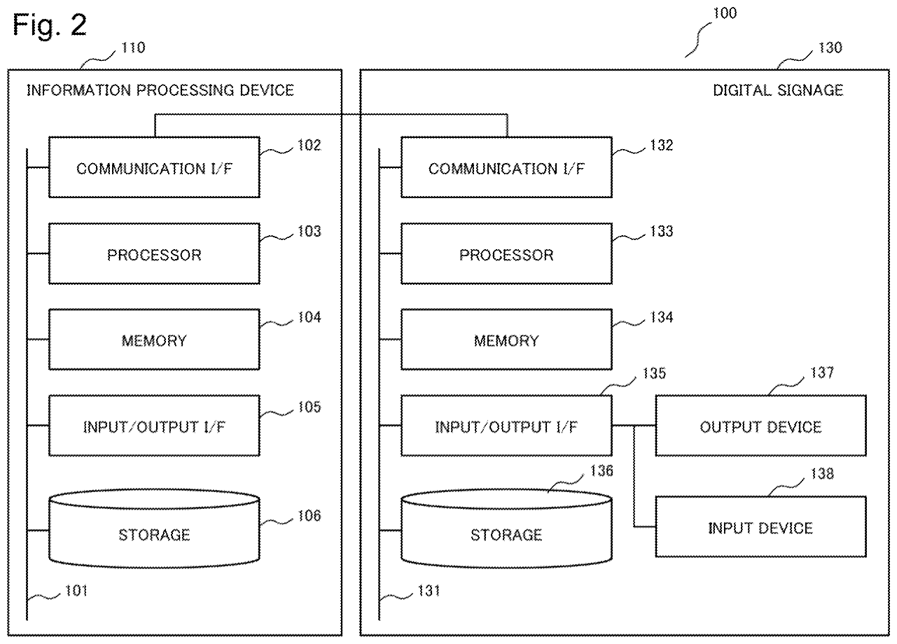

FIG. 2 is a view illustrating hardware configurations of the information processing device 110 and the digital signage 130 according to the first example embodiment and another example embodiment.

The information processing device 110 includes a bus 101, a communication interface 102, a processor 103, a memory 104, an input/output interface 105, and a storage 106. The bus 101 is a data transmission path for transmitting/receiving data. The communication interface 102, the processor 103, the memory 104, the input/output interface 105, and the storage 106 transmit/receive the data to/from each other via the bus 101. However, a method of connecting the processor 103 and the like to each other is not limited to bus connection.

The communication interface 102 is an interface for connecting the information processing device 110 to various networks and allowing the same to communicate with an external device (for example, the digital signage 130) via the network.

The processor 103 is an arithmetic processing unit such as a central processing unit (CPU) and a graphics processing unit (GPU). The memory 104 is a memory such as a random access memory (RAM) and a read only memory (ROM). The storage 106 is a storage device such as a hard disk drive (HDD), a solid state drive (SSD), and a memory card. The storage 106 may also be a memory such as a RAM and a ROM.

The storage 106 stores program modules that implement the above-described functional components (the attribute estimation unit 111, the input/output control unit 112, and the output unit 113) of the information processing device 110. The processor 103 executes the program modules to implement the functional components related to the program modules. Here, when executing the above-described program modules, the processor 103 may execute the program modules after reading out the same on the memory 104, or may execute the program modules without reading the same on the memory 104. The storage 106 may also function as the storage unit 114.

The input/output interface 105 is an interface for connecting the information processing device 110 to an input/output device. For example, an input device such as a mouse and a keyboard, a display device such as a liquid crystal display, an organic light emitting diode (OLED) display, and a light emitting diode (LED) display, a touch panel in which the input device and the display device are integrated and the like are connected to the input/output interface 105. It is not required that the input device and the display device be connected to the input/output interface 105.

The digital signage 130 includes a bus 131, a communication interface 132, a processor 133, a memory 134, an input/output interface 135, and a storage 136. The bus 131 is a data transmission path for transmitting/receiving data. The communication interface 132, the processor 133, the memory 134, the input/output interface 135, and the storage 136 transmit/receive the data to/from each other via the bus 131. However, a method of connecting the processor 133 and the like to each other is not limited to bus connection.

The communication interface 132 is an interface for connecting the digital signage 130 to various networks and allowing the same to communicate with an external device (for example, the information processing device 110 and the like) via the network.

The processor 133 is an arithmetic processing unit such as a CPU and a GPU. The memory 134 is a memory such as a RAM and a ROM. The storage 136 is a storage device such as an HDD, an SSD, and a memory card. The storage 136 may also be a memory such as a RAM and a ROM.

The storage 136 stores a program module that implements a function of displaying a screen including the survey read out by the information processing device 110 and an advertisement. The storage 136 stores a program module that implements a function of receiving the survey answer input to an input device 138 and outputting the same to the information processing device 110. The processor 133 executes the above-described program module to allow an output device 137 of the digital signage 130 to display a screen including the survey. The processor 133 receives the survey answer input to the input device 138 of the digital signage 130 and outputs the same to the information processing device 110 by executing the above-described program module. Here, when executing the above-described program modules, the processor 133 may execute the program modules after reading out the same on the memory 134, or may execute the program modules without reading the same on the memory 134.

The input/output interface 135 is an interface for connecting the digital signage 130 to an input/output device. A display device such as a liquid crystal display, an OLED display, and an LED display is connected to the input/output interface 135. The input device 138 such as a mouse and a keyboard may be connected to the input/output interface 135. A touch panel in which the input device and the display device are integrated with each other may be connected to the input/output interface 135. In the first example embodiment, suppose that the touch panel is connected to the input/output interface 135. A speaker may be connected as the output device 137, and a microphone may be connected as the input device 138.

The hardware configurations of the information processing device 110 and the digital signage 130 are not limited to the configuration illustrated in FIG. 2.

<Operation Example>

Hereinafter, an operation example in the first example embodiment is described with reference to the drawings.

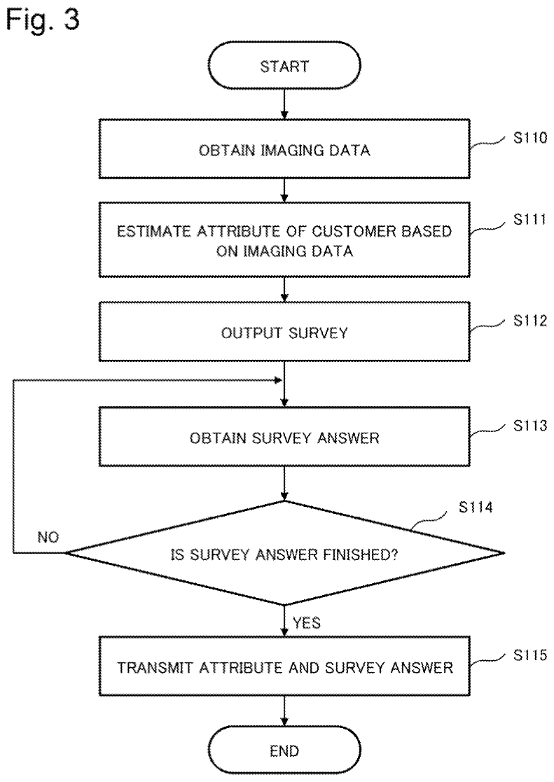

FIG. 3 is a flowchart illustrating an example of an operation of the information processing system 100 according to the present first example embodiment. Processing in FIG. 3 starts, for example, when a customer is detected in a region in the vicinity of the digital signage 130. The customer may be detected by using an existing technology such as, for example, a human sensor, a ranging device such as a light detection and ranging (LiDAR) device, analysis of in-store imaging data and the like. When the customer is not detected, the information processing device 110 may allow the digital signage 130 to display the advertisement.

When the customer is detected in the vicinity of the digital signage 130, the information processing device 110 obtains the imaging data from the imaging device 120 (step S110). The imaging device 120 constantly performs imaging, and when the customer is detected in the vicinity of the digital signage 130, the information processing device 110 may obtain the imaging data, or when the customer is detected in the vicinity of the digital signage 130, the information processing device 110 may control the imaging device 120 to image an imaging region.

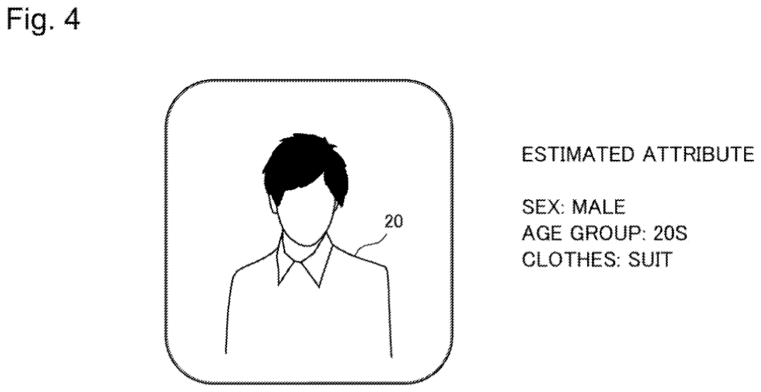

The attribute estimation unit 111 estimates the attribute of the customer included in the obtained imaging data (step S111). FIG. 4 is a view illustrating an example of the attribute estimated by the attribute estimation unit 111 on the basis of the imaging data. The example in FIG. 4 illustrates that the attributes of a customer 20 included in the imaging data are estimated to be “sex: male”, “age group: twenties”, and “clothes: suit”. The attribute estimation unit 111 stores the estimated attributes of the customer in the storage unit 114.

The input/output control unit 112 reads out the survey data from the storage unit 114 and controls the display device of the digital signage 130 to output (display) the survey based on the survey data (step S112).

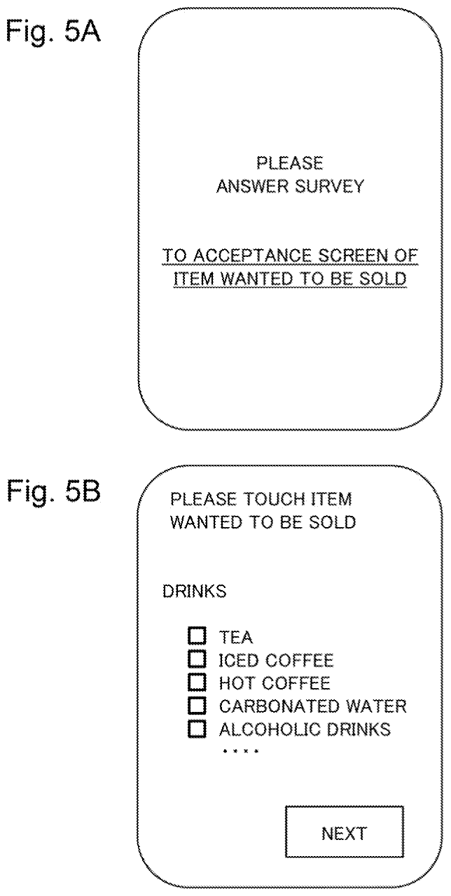

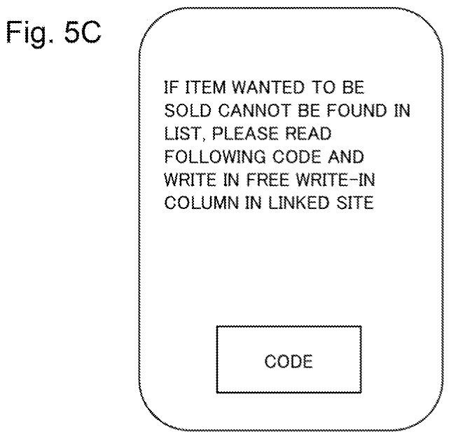

FIGS. 5A to 5C are views illustrating a display example of the digital signage 130 by the input/output control unit 112. The input/output control unit 112 may display a screen requesting the answer to the survey as illustrated in FIG. 5A, for example, at a timing when the customer is detected in the vicinity of the digital signage 130.

The input/output control unit 112 may select next survey data to output on the basis of the answer obtained from the customer. For example, in the example in FIG. 5A, when the customer touches a display of “To acceptance screen of item wanted to be sold”, the input/output control unit 112 may receive the touch as the answer and display a screen illustrated in FIG. 5B. In the example illustrated in FIG. 5B, a candidate item list to be sold is displayed. The customer touches any one in the item list. The input/output control unit 112 receives the touch of the customer and obtains the same as the answer to the survey (step S 113).

As illustrated in FIG. 5C, the input/output control unit 112 may display a code for a link to a predetermined site with a free write-in column on the digital signage 130. The code may be, for example, a two-dimensional barcode. The customer may read out the code via his/her smartphone and the like and input the item wanted to be sold in the free write-in column of the linked site. The input/output control unit 112 not only displays the code but also displays the free write-in column.

Here, as described above, the attribute estimation unit 111 estimates the attribute of the customer from the imaging data. Therefore, according to the present example embodiment, it is not necessary to input the attribute of the customer to the survey.

In a case where the answer to the survey cannot be obtained for a predetermined time, the input/output control unit 112 may stop displaying the survey on the digital signage 130. In this case, the input/output control unit 112 not only stops displaying the survey but also may switch the display of the survey to the display of the advertisement.

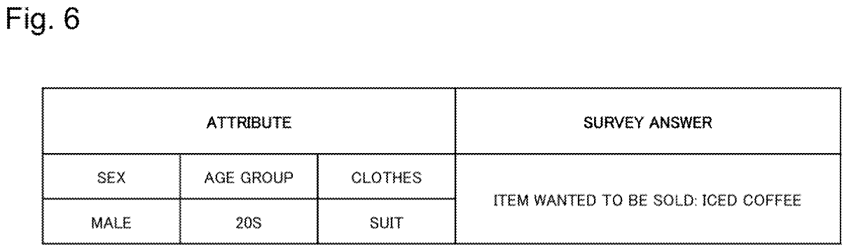

When detecting that the reception of the survey is finished (Yes at step S114), the input/output control unit 112 stores the survey answer in the storage unit 114 in association with the attributes of the customer stored in the storage unit 114 at step S111 described above. FIG. 6 is a view illustrating an example of the attributes of the customer and the survey answer stored in the storage unit 114. The input/output control unit 112 may detect that the reception of the survey is finished, for example, by detecting that the customer press a finish button of the survey answer. In a case where the answer to the survey cannot be obtained for a predetermined time, the input/output control unit 112 may receive “no answer” as the survey answer and detect that the survey answer is finished.

The input/output control unit 112 instructs the output unit 113 to output to the management server 10. In response to the above-described instruction, the output unit 113 transmits the above-described estimated attributes of the customer and the above-described received survey answer to the management server 10 in association with each other (step S115).

The management server 10 may obtain the above-described survey answer and attributes of the customer, thereby using the information in store operation, for example. It is possible to reflect the same in ordering; for example, the item frequently wanted to be sold is newly sold. It is possible to change types of the item sold in the store and the order quantity of the item according to the sex and age group of the customers. As a result, the store may prevent a sales opportunity loss.

The output unit 113 not only transmits the survey answer and the attributes of the customer to the management server 10 at a timing when the survey answer is obtained. For example, this may accumulate the survey answers and the attributes of the customers in the storage unit 114 of the information processing device 110 and transmit the same to the management server 10 at a predetermined timing. An output destination of the survey answer and the attributes of the customer by the output unit 113 is not limited to the management server 10. For example, the destination may be a customer terminal or a store staff terminal.

<Effect>

As described above, according to the present first example embodiment, the information processing system 100 displays the survey on the digital signage 130 installed in the store and receives the answer to the survey by the input/output control unit 112. The attribute estimation unit 111 estimates the attribute of the customer from the imaging data. The output unit 113 transmits these pieces of information to the management server 10. By adopting this configuration, it is possible to obtain the survey answer including the attribute of the customer from the customer without necessity of the input of the attribute, so that it is possible to obtain an effect of obtaining the customer's request and the like while saving time and effort of the customer. Since the attribute of the customer are estimated from the imaging data, an effect of preventing an input mistake by the customer may be obtained.

The input/output control unit 112 may allow the display device of the digital signage 130 to display the attribute estimated by the attribute estimation unit 111. The input device may receive from the customer correctness of the estimated attribute displayed on the display device. Furthermore, the input device of the digital signage 130 may receive an input of correction of the estimated attribute. As a result, an effect of improving accuracy of the obtained attribute of the customer may be obtained. The input/output control unit 112 may allow the digital signage 130 to display the survey answer.

The input/output control unit 112 may also be configured to output the survey suitable for the customer with the attribute estimated by the attribute estimation unit 111.

The information processing device 110 may store advertisement data and sales ranking information of the item associated with the attribute, and display the advertisement regarding a related item on the basis of the obtained survey answer and the estimated attribute. For example, the information processing device 110 may display the advertisement for recommending an item similar to the item wanted by the customer to be sold. For example, suppose that the survey answer indicating that the customer whose attributes are estimated to be “twenties” and “male” wants that “∘∘ coffee” is sold is obtained. At that time, after obtaining the above-described answer to the survey, the input/output control unit 112 may determine a recommended item on the basis of the sales ranking of men in their twenties in a “coffee” category, for example, read out the advertisement data regarding the item, and allows the digital signage 130 to display the advertisement.

### Second Example Embodiment

An information processing system according to a second example embodiment is described. The same reference sign as that assigned in the drawings of the first example embodiment denotes the same functional component, and the description of the functional component is not repeated.

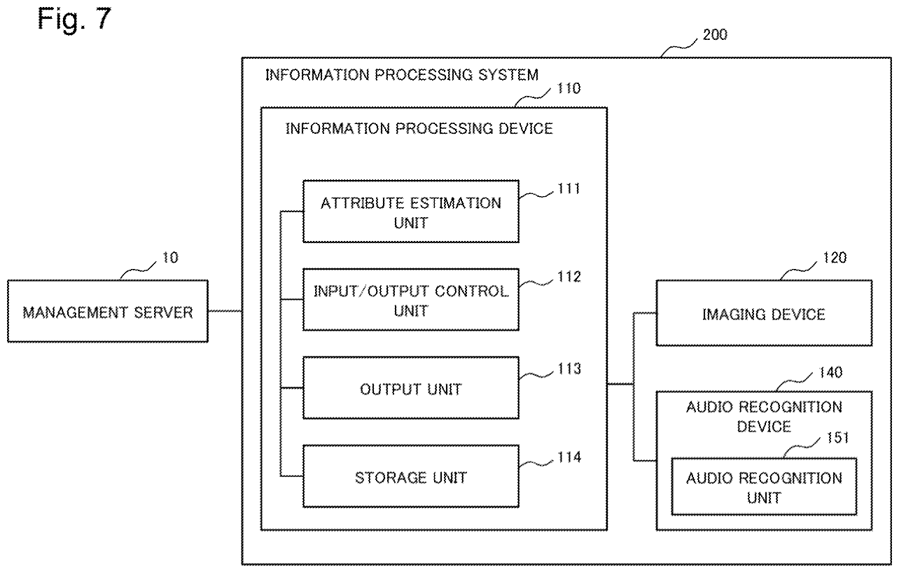

FIG. 7 is a block diagram illustrating a configuration of an information processing system 200 according to a second example embodiment. The information processing system 200 includes a voice recognition device 140 in place of the digital signage 130 of the information processing system 100 described in the first example embodiment.

The voice recognition device 140 includes an output device and an input device, and is further includes a voice recognition unit 151 that performs voice recognition processing. The voice recognition device 140 outputs information by voice under control of the information processing device 110, receives a voice of a customer and performs voice recognition, and notifies the information processing device 110 of the same. The voice recognition device 140 may be, for example, a robot type device having a function of talking with a human.

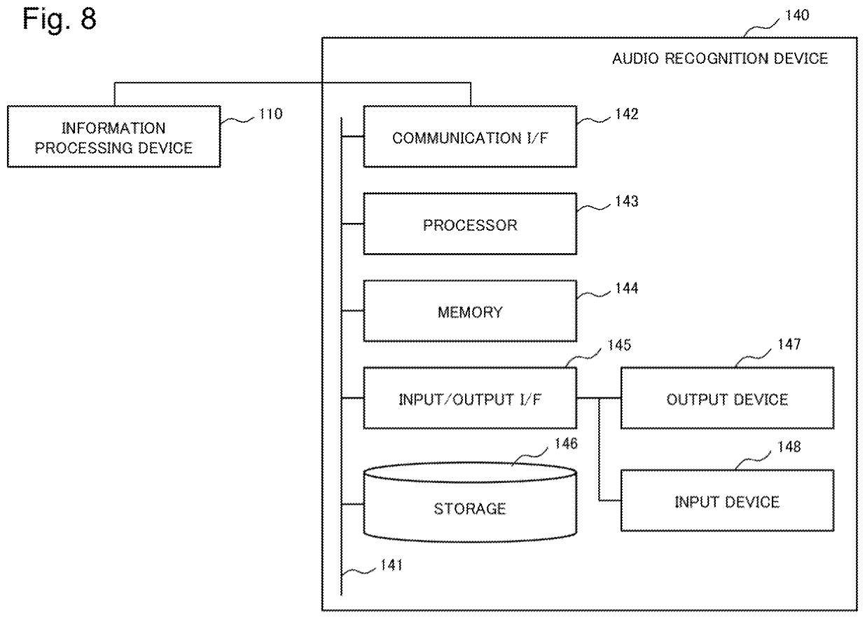

FIG. 8 is a view illustrating a hardware configuration of the voice recognition device 140.

The voice recognition device 140 includes a bus 141, a communication interface 142, a processor 143, a memory 144, an input/output interface 145, and a storage 146. The bus 141 is a data transmission path for transmitting/receiving data. The communication interface 142, the processor 143, the memory 144, the input/output interface 145, and the storage 146 transmit/receive data to/from each other via the bus 141. However, a method of connecting the processor 143 and the like to each other is not limited to bus connection.

The communication interface 142 is an interface for connecting the voice recognition device 140 to various networks and allowing the same to communicate with an external device (for example, an information processing device 110 and the like) via the network.

The processor 143 is an arithmetic processing unit such as a CPU and a GPU. The memory 144 is a memory such as a RAM and a ROM. The storage 146 is a storage device such as an HDD, an SSD, and a memory card. The storage 146 may also be a memory such as a RAM and a ROM.

The storage 146 stores a program module that implements a function of outputting a survey read out by the information processing device 110 by voice. The storage 146 stores a program module that implements a function of performing voice recognition of a survey answer input to an input device 148 by voice such as voice of a customer and outputting a result to the information processing device 110. The processor 143 executes the above-described program module to output by voice the survey to the output device 147 of the voice recognition device 140. The processor 143 performs voice recognition of the survey answer input by voice to the input device 148 of the voice recognition device 140 and outputs a result to the information processing device 110 by executing the above-described program module. Here, when executing the above-described program modules, the processor 143 may execute the program modules after reading out the same on the memory 144, or may execute the program modules without reading the same on the memory 144.

The input/output interface 145 is an interface for connecting the voice recognition device 140 to an input/output device. An output device 147 that outputs voice is connected to the input/output interface 145. The input device 148 that obtains the voice such as the voice of the customer is connected to the input/output interface 145. In the present example embodiment, the output device 147 is, for example, a speaker, and the input device 148 is, for example, a microphone. An LCD and the like may be connected as the output device 147, and a mouse, a keyboard and the like may be connected as the input device 148.

A hardware configuration of the voice recognition device 140 is not limited to the configuration illustrated in FIG. 8.

An operation of the information processing system 200 of the second example embodiment is similar to the operation of the information processing system 100 of the first example embodiment described with reference to FIG. 3. However, the input/output to/from the customer are performed by voice.

Specifically, an input/output control unit 112 of the information processing device 110 reads out survey data from a storage unit 114 and controls the voice recognition device 140 to output by voice a survey content based on the survey data at step S112 in FIG. 3. That is, in the present example embodiment, the output device corresponds to a voice recognition device, and the input/output control unit 112 allows the output device to output the survey by voice.

In accordance with the above-described control, the voice recognition device 140 performs voice conversion on the survey data in the voice recognition unit 151, and outputs the survey by voice from the output device 147. The information processing device 110 or the voice recognition device 140 may store voice data indicating the survey content in advance, and the voice recognition unit 151 may output the voice data from the output device 147.

In the voice recognition device 140, the input device 148 obtains an answer by voice of the customer to the above-described survey. The voice recognition unit 151 performs voice recognition processing on the obtained voice and notifies the information processing device 110 of a result. The input/output control unit 112 according to the present example embodiment receives information of a result of the voice recognition of the voice of the customer by the voice recognition device 140 as the answer. The information processing device 110 may select a next survey on the basis of the answer obtained from the customer to output.

As described above, according to the present second example embodiment, in addition to the effect by the first example embodiment, the information processing system 200 may obtain an effect of obtaining the answer to the survey not only by display information but also by voice information. For example, it is possible to obtain the survey answer from customers who are using both hands or visually impaired customers.

For the customer, there is an effect that he/she may answer the survey in a non-contact manner.

### Third Example Embodiment

An information processing system according to a third example embodiment is described. The same reference sign as that assigned in the drawings of the first example embodiment denotes the same functional component, and the description of the functional component is not repeated.

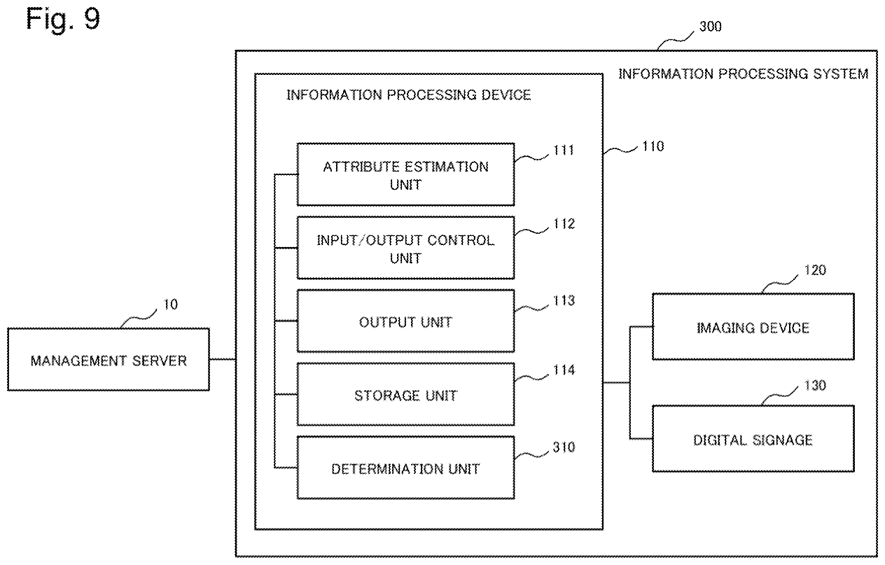

FIG. 9 is a block diagram illustrating a configuration of an information processing system 300 according to the third example embodiment. An information processing device 110 of the information processing system 300 includes a determination unit 310 in addition to the information processing device 110 of the information processing system 100 described in the first example embodiment. A storage unit 114 stores customer identification information in addition to survey data. The information processing system 300 may include the voice recognition device 140 described in the second example embodiment in place of a digital signage 130, or may include both the digital signage 130 and the voice recognition device 140.

On the basis of imaging data obtained from an imaging device 120, the determination unit 310 determines whether an imaged customer is a customer whose survey answer is already received. The determination unit 310 corresponds to a determination means that determines whether a customer is a customer whose answer to a survey is received on the basis of imaging data.

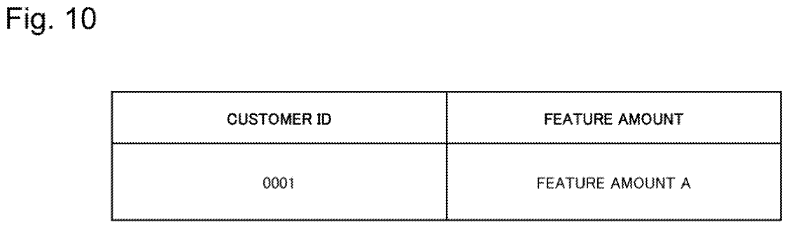

The determination unit 310 may perform the above-described determination, for example, as follows. That is, when the imaging data is obtained from the imaging device 120 at step S111 described with reference to FIG. 3 in the first example embodiment, the determination unit 310 extracts a feature amount of an appearance of the customer from the imaging data. The determination unit 310 stores the above-described extracted feature amount in the storage unit 114 as the customer identification information in association with identification information assigned to this customer at a timing when an input/output control unit 112 finishes receiving the survey answer. FIG. 10 is a view illustrating an example of the customer identification information. Thereafter, when the imaging data is obtained from the imaging device 120, the determination unit 310 extracts the feature amount of the appearance of the customer from the imaging data. The determination unit 310 determines whether the customer is the customer whose survey answer is already received on the basis of the extracted feature amount and the feature amount included in the customer identification information stored in the storage unit 114.

The determination unit 310 may also specify the customer by, for example, face authentication processing and determine whether the customer is the customer whose survey answer is already received. That is, the determination unit 310 may perform the above-described determination by specifying the customer using the imaging data and a database in which the feature amount of the appearance of the customer is registered in advance. An existing technology may be used in the face authentication processing.

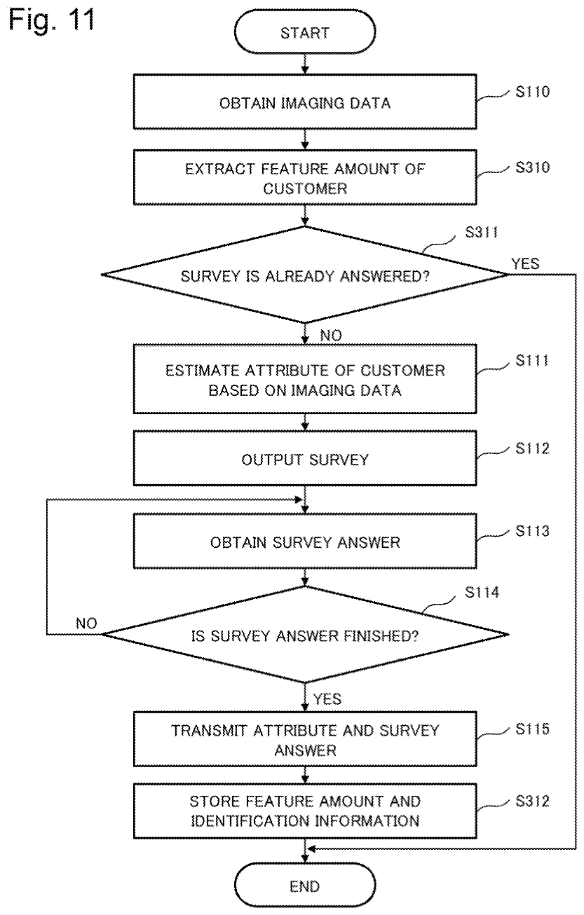

FIG. 11 is a flowchart illustrating an example of an operation of the information processing system 300 according to the present third example embodiment. An operation example in the third example embodiment is described with reference to FIG. 11. The same reference sign as that assigned in FIG. 3 denotes the same processing, and the description of the processing is not repeated. Processing in FIG. 11 starts, for example, when a customer is detected in a region in the vicinity of the digital signage 130 as in the processing in FIG. 3.

When the customer is detected in the vicinity of the digital signage 130, the imaging data is obtained from the imaging device 120 (step S110).

The determination unit 310 extracts the feature amount of the customer included in the imaging data obtained from the imaging device 120 (step S310). The determination unit 310 determines whether the customer is the customer whose answer to the survey is already received (step S311). In a case where the customer identification information including the same feature amount as the feature amount of the customer extracted from the imaging data is stored in the storage unit 114, for example, as described above, the determination unit 310 determines that the customer is the customer whose answer to the survey is already received.

In a case where the customer is not the customer whose answer to the survey is received (No at step S311), that is, in a case of a customer who answers the survey for the first time, the information processing system 300 performs the processing at steps S111 to S114 in a manner similar to that in the first example embodiment. Then, the determination unit 310 stores the feature amount extracted at step 5310 in the storage unit 114 in association with the identification information assigned to this customer (step S312).

On the other hand, in a case of the customer whose answer to the survey is received (Yes at step S311), the information processing system 300 finishes the processing. That is, the information processing system 300 does not output the survey. The information processing system 300 does not receive the answer to the survey. Alternatively, it is also possible that the input/output control unit 112 does not perform at least the reception of the answer to the survey out of the output of the survey and the reception of the answer to the survey. The input/output control unit 112 may control so as not to transit to a screen for receiving the survey answer as illustrated in FIG. 5B after displaying a screen illustrated in FIG. 5A, for example.

The input/output control unit 112 may output an alarm. For example, the input/output control unit 112 may allow a display device of the digital signage 130 to display that the survey is already answered. Alternatively, the input/output control unit 112 may output by voice that the survey is already answered.

As described above, according to the present third example embodiment, the determination unit 310 of the information processing device 110 determines whether the customer is the customer whose answer to the survey is already received, and in a case of the customer whose answer is not received, the input/output control unit 112 receives the survey answer. By adopting this configuration, according to the present third example embodiment, it is possible to prevent redundant reception of the survey from the same customer, so that it is possible to obtain an effect of improving accuracy of the survey.

The information processing device 110 may determine whether the customer is a person who answers the survey, and control the output of the survey on the basis of the determination. In a case where the answer to the survey cannot be obtained for a predetermined time at step S113 in FIG. 11, the input/output control unit 112 may receive “no answer” as the survey answer and detect that the survey answer is finished. In this case, at step S312, the determination unit 310 stores the survey answer indicating “no answer” in the storage unit 114 in association with the identification information assigned to the customer together with the feature amount extracted at step S310.

In a case of determining that the customer is the customer whose answer to the survey is received at step S311, the determination unit 310 further determines whether the survey answer of this customer stored in the storage unit 114 is “no answer”. In a case of “no answer”, the information processing device 110 may finish the processing without outputting the survey. As a result, the information processing device 110 may output the survey to the customer who is more likely to answer the survey. The determination unit 310 may also store the identification information of the survey together with the survey answer in the storage unit 114, and output another survey to the customer of “no answer”.

At step S312, the determination unit 310 may store the survey answer in the storage unit 114 in association with the identification information assigned to the customer together with the feature amount. In this case, the input/output control unit 112 may allow the digital signage 130 to display, for the customer determined to be the customer whose answer to the survey is already received at step S311, an advertisement for recommending an item similar to the item which the customer answered that he/she wants that the item is sold. Alternatively, in a case where the item wanted to be sold in the answer is started to be sold, the input/output control unit 112 may allow the digital signage 130 to display the advertisement indicating that the item is being sold.

### Fourth Example Embodiment

An information processing system according to a fourth example embodiment is described. In the present fourth example embodiment, it is described that the information processing device 110 of the information processing system 100 described in the first example embodiment outputs a survey regarding an item displayed on an item shelf associated with a digital signage 130. The item shelf associated with the digital signage 130 is, for example, an item shelf on which the digital signage 130 is installed or an item shelf in the vicinity of the installed digital signage 130.

A storage unit 114 of the information processing device 110 stores associated information in which identification information (ID) of the digital signage 130, identification information of the item shelf, and survey data are associated with each other in advance. The survey data includes a survey content regarding the item displayed on the item shelf associated with the digital signage 130.

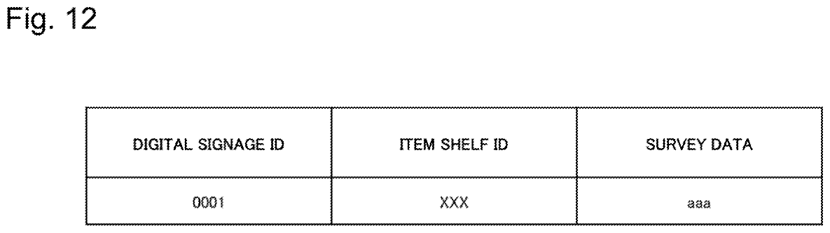

FIG. 12 is a view illustrating an example of the associated information stored in the storage unit 114 of the information processing system according to the fourth example embodiment. The associated information includes a digital signage ID, an item shelf ID, and survey data.

At step S112 described with reference to FIG. 3, an input/output control unit 112 reads out a survey related to the item on the item shelf associated with the digital signage 130 from the storage unit 114, and outputs the same to the digital signage 130.

Here, it is considered that a customer located in the vicinity of a certain item shelf is highly interested in the item displayed on the item shelf. In the present example embodiment, since the survey regarding the item displayed on the item shelf is output to the digital signage 130 installed on the item shelf or installed in the vicinity of the item shelf, it is highly possible that a survey answer may be obtained from the customer who is highly interested in the item. Therefore, according to the present example embodiment, it is possible to obtain an effect that the survey answer with high accuracy may be obtained.

In a case where a plurality of digital signages 130 is installed in the store and controlled by the information processing device 110, the storage unit 114 may store the associated information including the item shelf IDs and the survey data associated with the plurality of digital signages 130. In this case, the input/output control unit 112 may hold identification information of each digital signage 130 in advance, read out the survey data associated with each digital signage 130, and output the same to the associated digital signage 130.

### Fifth Example Embodiment

### An information processing device according to a fifth example embodiment is described.

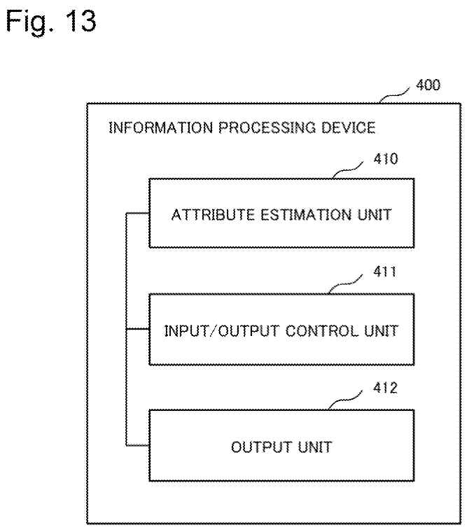

FIG. 13 is a block diagram illustrating an example of a configuration of an information processing device 400 according to the fifth example embodiment. As illustrated in FIG. 13, the information processing device 400 includes an attribute estimation unit 410, an input/output control unit 411, and an output unit 412.

The attribute estimation unit 410 estimates, on the basis of imaging data in which a customer who visits a store is imaged, an attribute of this customer. The input/output control unit 411 outputs a survey to an output device in a store and receives an answer to this survey. The output unit 412 outputs the estimated attribute and the received answer in association with each other.

By adopting the above-described configuration, according to the present fifth example embodiment, the information processing device 400 estimates the attribute of the customer and outputs the same in association with the received answer to the survey, so that it is possible to obtain an effect of receiving an input from the customer while saving time and effort.

While the present disclosure has been particularly shown and described with reference to exemplary embodiments thereof, the present disclosure is not limited to these exemplary embodiments. For example, the configurations in the example embodiments may be combined with each other without departing from the scope of the present disclosure. For example, the information processing system may include both the digital signage 130 and the voice recognition device 140. In this case, the survey may be displayed on the display device of the digital signage 130, and the survey may be output by voice in the voice recognition device 140. At that time, the content displayed on the display device and the content output by voice may be the same or different from each other.

For example, a plurality of voice recognition devices 140 may be communicably connected to the information processing system, and each voice recognition device 140 may output by voice the survey regarding the item on the item shelf associated in advance.

It will be understood by those of ordinary skill in the art that various changes in form and details may be made therein without departing from the spirit and scope of the present disclosure as defined by the claims. For example, an example embodiment obtained by adding a partial configuration of any example embodiment to another example embodiment or an example embodiment in which a partial configuration of any example embodiment is replaced with a partial configuration of another example embodiment is also an example embodiment to which the present disclosure may be applied.

Furthermore, in a plurality of flowcharts used in the above-described description, a plurality of steps (processes) are described in order, but the execution order of the steps executed in each example embodiment is not limited to the described order. In each example embodiment, the order of the illustrated steps may be changed as long as there is no problem in terms of content.

A processing method of allowing a recording medium to record a program for operating a configuration of each of the above-described example embodiments so as to implement a function of the same, reading the program recorded in the recording medium as a code, and executing the same in a computer is also included in the scope of each example embodiment. That is, a computer-readable recording medium is also included in the scope of each example embodiment. Not only the recording medium in which the above-described computer program is recorded but also the computer program itself is included in each example embodiment.

As the recording medium, a floppy (registered trademark) disk, a hard disk, an optical disk, a magneto-optical disk, a compact disc-read only memory (CD-ROM), a magnetic tape, a nonvolatile memory card, and a ROM may be used, for example. Not only the one that executes the processing by the program alone recorded in the recording medium but also the one that executes the processing on an operating system (OS) in corporation with a function of other software and extension board is included in the scope of each example embodiment.

Some or all of the above-described example embodiments may be described as in the following supplementary notes, but are not limited to the following.

(Supplementary Note 1)

An information processing device including:

an attribute estimation means for estimating, based on imaging data in which a customer who visits a store is imaged, an attribute of the customer;

an input/output control means for outputting a survey to an output device in the store and receiving an answer to the survey; and

an output means for outputting the estimated attribute and the received answer in association with each other.

(Supplementary Note 2)

The information processing device according to supplementary note 1, wherein the input/output control means causes the output device to display the survey, and receives the answer input to the output device.

(Supplementary Note 3)

The information processing device according to supplementary note 1 or 2, wherein

the input/output control means causes the output device to output the survey by voice, and receives information of a result of voice recognition of voice of the customer as the answer.

(Supplementary Note 4)

The information processing device according to any one of supplementary notes 1 to 3, further including:

a determination means for determining whether the customer is a customer whose answer to the survey is received based on the imaging data, wherein

in a case of the customer whose answer to the survey is received, the input/output control means does not perform, out of an output of the survey and reception of the answer to the survey, at least the reception of the answer to the survey.

(Supplementary Note 5)

The information processing device according to any one of supplementary notes 1 to 4, further including:

a determination means for determining whether the customer is the customer whose answer to the survey is received based on the imaging data, wherein

in a case of the customer whose answer to the survey is received, the input/output control means outputs an alarm.

(Supplementary Note 6)

The information processing device according to supplementary note 4 or 5, wherein

in a case where the answer to the survey is not obtained for a predetermined time, the input/output control means receives information indicating no answer as the answer to the survey, and

in a case where the customer is the customer whose answer to the survey is received and the answer is the information indicating no answer, the input/output control means does not output the survey.

(Supplementary Note 7)

The information processing device according to any one of supplementary notes 1 to 6, wherein

the input/output control means outputs an advertisement determined based on the estimated attribute and the received answer to the output device.

(Supplementary Note 8)

The information processing device according to supplementary note 7, wherein

the input/output control means outputs the advertisement of an item associated with the estimated attribute out of items related to an item included in the received answer to the output device.

(Supplementary Note 9)

The information processing device according to any one of supplementary notes 1 to 8, wherein

the input/output control means outputs a survey regarding an item displayed on an item shelf associated with the output device to the output device.

(Supplementary Note 10)

The information processing device according to any one of supplementary notes 1 to 9, wherein

the input/output control means outputs the estimated attribute to the output device and receives correctness of the output attribute from the customer.

(Supplementary Note 11)

A management system including:

an information processing device including:

an attribute estimation means for estimating, based on imaging data in which a customer who visits a store is imaged, an attribute of the customer;

an input/output control means for outputting a survey to an output device in the store and receiving an answer to the survey; and

an output means for outputting the estimated attribute and the received answer in association with each other to another information processing device communicably connected to the information processing device.

(Supplementary Note 12)

An information processing method including:

estimating, based on imaging data in which a customer who visits a store is imaged, an attribute of the customer;

outputting a survey to an output device in the store and receiving an answer to the survey; and

outputting the estimated attribute and the received answer in association with each other.

(Supplementary Note 13)

The information processing method according to supplementary note 12, including:

allowing the output device to display the survey; and

receiving the answer input to the output device.

(Supplementary Note 14)

The information processing method according to supplementary note 12 or 13, including:

allowing the output device to output the survey by voice; and receiving information of a result of voice recognition of voice of the customer as the answer.

(Supplementary Note 15)

The information processing method according to any one of supplementary notes 12 to 14, including:

determining whether the customer is a customer whose answer to the survey is received based on the imaging data, wherein

in a case of the customer whose answer to the survey is received, out of an output of the survey and reception of the answer to the survey, at least the reception of the answer to the survey is not performed.

(Supplementary Note 16)

The information processing method according to any one of supplementary notes 12 to 15, including:

determining whether the customer is the customer whose answer to the survey is received based on the imaging data; and

outputting an alarm in a case of the customer whose answer to the survey is received.

(Supplementary Note 17)

The information processing method according to supplementary note 15 or 16, including:

receiving information indicating no answer as the answer to the survey in a case where the answer to the survey is not obtained for a predetermined time, in which

in a case where the customer is the customer whose answer to the survey is received and the answer is the information indicating no answer, the survey is not output.

(Supplementary Note 18)

The information processing method according to any one of supplementary notes 12 to 17, including:

outputting an advertisement determined based on the estimated attribute and the received answer to the output device.

(Supplementary Note 19)

The information processing method according to supplementary note 18, including:

outputting the advertisement of an item associated with the estimated attribute out of items related to an item included in the received answer to the output device.

(Supplementary Note 20)

The information processing method according to any one of supplementary notes 12 to 19, including:

outputting a survey regarding an item displayed on an item shelf associated with the output device to the output device.

(Supplementary Note 21)

The information processing method according to any one of supplementary notes 12 to 20, including:

outputting the estimated attribute to the output device and receiving correctness of the output attribute from the customer.

(Supplementary Note 22)

A recording medium that records a program for causing a computer to execute processing of:

estimating, based on imaging data in which a customer who visits a store is imaged, an attribute of the customer;

outputting a survey to an output device in the store and receiving an answer to the survey; and

outputting the estimated attribute and the received answer in association with each other.

The present invention has been described with reference to the above-described example embodiments as exemplary examples. However, the present invention is not limited to the above-described example embodiments. That is, it will be understood by those of ordinary skill in the art that various modes may be applied to the present invention without departing from the spirit and scope of the present invention as defined by the claims.

This application is based upon and claims the benefit of priority from Japanese patent application No. 2019-55918, filed on Mar. 25, 2019, the disclosure of which is incorporated herein in its entirety by reference.

### REFERENCE SIGNS LIST

10 management server
100 information processing system
110 information processing device
111 attribute estimation unit
112 input/output control unit
113 output unit
114 storage unit
120 imaging device
130 digital signage

What is claimed is:

1. An information processing device comprising:
at least one memory storing instructions; and
at least one processor configured to access the at least one memory and execute the instructions to:
estimate an attribute of a customer based on imaging data in which the customer who visits a store is imaged;
output a survey to an output device in the store and receive an answer to the survey; and
output the estimated attribute and the received answer in association with each other.

2. The information processing device according to claim 1, wherein
the at least one processor is further configured to execute the instructions to:
cause the output device to display the survey, and receive the answer input to the output device.

3. The information processing device according to , claim 1 wherein
the at least one processor is further configured to execute the instructions to:
cause the output device to output the survey by voice, and receives information of a result of voice recognition of voice of the customer as the answer.

4. The information processing device according to claim 1, wherein
the at least one processor is further configured to execute the instructions to:
determine whether the customer is a customer whose answer to the survey is received based on the imaging data; and
in a case of the customer whose answer to the survey is received, stop at least reception of the answer to the survey, out of an output of the survey and the reception of the answer to the survey.

5. The information processing device according to claim 1, wherein
the at least one processor is further configured to execute the instructions to:
determine whether the customer is the customer whose answer to the survey is received based on the imaging data; and
in a case of the customer whose answer to the survey is received, output an alarm.

6. The information processing device according to claim 4, wherein
the at least one processor is further configured to execute the instructions to:
in a case where the answer to the survey is not obtained for a predetermined time, receive information indicating no answer as the answer to the survey; and
in a case where the customer is the customer whose answer to the survey is received and the answer is the information indicating no answer, output none of the survey.

7. The information processing device according to claim 1 wherein
the at least one processor is further configured to execute the instructions to:
output an advertisement determined based on the estimated attribute and the received answer to the output device.

8. The information processing device according to claim 7, wherein
the at least one processor is further configured to execute the instructions to:
output the advertisement of an item associated with the estimated attribute out of items related to an item included in the received answer to the output device.

9. The information processing device according to claim 1, wherein
the at least one processor is further configured to execute the instructions to:
output a survey regarding an item displayed on an item shelf associated with the output device to the output device.

10. The information processing device according to claim 1, wherein
the at least one processor is further configured to execute the instructions to:
output the estimated attribute to the output device and receives correctness of the output attribute from the customer.

11. (canceled)

12. An information processing method comprising:
estimating, based on imaging data in which a customer who visits a store is imaged, an attribute of the customer;
outputting a survey to an output device in the store and receiving an answer to the survey; and
outputting the estimated attribute and the received answer in association with each other.

13. The information processing method according to claim 12, comprising:
allowing the output device to display the survey; and
receiving the answer input to the output device.

14. The information processing method according to claim 12, comprising:
allowing the output device to output the survey by voice; and receiving information of a result of voice recognition of voice of the customer as the answer.

15. The information processing method according to claim 12, comprising:
determining whether the customer is a customer whose answer to the survey is received based on the imaging data, wherein
in a case of the customer whose answer to the survey is received, out of an output of the survey and reception of the answer to the survey, at least the reception of the answer to the survey is stopped.

16. The information processing method according to claim 12, comprising:
determining whether the customer is the customer whose answer to the survey is received based on the imaging data; and
outputting an alarm in a case of the customer whose answer to the survey is received.

17. The information processing method according to claim 15, comprising:
receiving information indicating no answer as the answer to the survey in a case where the answer to the survey is not obtained for a predetermined time, wherein
in a case where the customer is the customer whose answer to the survey is received and the answer is the information indicating no answer, the survey is not output.

18. The information processing method according to claim 12, comprising:
outputting an advertisement determined based on the estimated attribute and the received answer to the output device.

19. The information processing method according to claim 18, comprising:
outputting the advertisement of an item associated with the estimated attribute out of items related to an item included in the received answer to the output device.

20. The information processing method according to claim 12, comprising:
outputting a survey regarding an item displayed on an item shelf associated with the output device to the output device.

21. (canceled)

22. A non-transitory computer readable recording medium that records a program for causing a computer to execute processing of:
estimating, based on imaging data in which a customer who visits a store is imaged, an attribute of the customer;
outputting a survey to an output device in the store and receiving an answer to the survey; and
outputting the estimated attribute and the received answer in association with each other.
